(19) United States
(12) Patent Application Publication
(10) Pub. No.: US 2023/0252866 A1
(43) Pub. Date: Aug. 10, 2023

(54) ASSISTIVE SLEEVE TO ENCODE RELEVANT SPATIAL INFORMATION FOR BLIND NAVIGATION IN A TACTILE FORMAT

(71) Applicants: Troy McDaniel, Gilbert, AZ (US); Yatiraj Shetty, Tempe, AZ (US); Shubham Gharat, Milpitas, CA (US)

(72) Inventors: Troy McDaniel, Gilbert, AZ (US); Yatiraj Shetty, Tempe, AZ (US); Shubham Gharat, Milpitas, CA (US)

(73) Assignee: Arizona Board of Regents on behalf of Arizona State University, Tempe, AZ (US)

(21) Appl. No.: 18/106,637

(22) Filed: Feb. 7, 2023

Related U.S. Application Data
(60) Provisional application No. 63/307,331, filed on Feb. 7, 2022.

(51) Int. Cl. G08B 6/00

(52) U.S. Cl. CPC G08B 6/00

(57) ABSTRACT

An assistive feedback device is described herein and includes an array of vibrotactile actuators and thermal units affixed on a flexible casing that can be worn around the forearm. The vibrotactile actuators are used for obstacle detection by using a customizable encoding format. The directional cues for navigation are provided using the thermal units in a customizable format.

### CROSS REFERENCE TO RELATED APPLICATIONS

This is a non-provisional application that claims benefit to U.S. Provisional Application Ser. No. 63/307,331, filed on Feb. 7, 2022, which is herein incorporated by reference in its entirety.

### FIELD

The present disclosure generally relates to assistive devices for impaired individuals, particularly to a system and associated method for providing spatial information encoded as vibrothermal feedback to a visually impaired user.

### BACKGROUND

Visually impaired individuals often rely on assistive devices that attempt to encode spatial information into other means such as audio or tactile signals. However, challenges in implementation and interpretation of spatial information still exist. For instance, many existing devices still provide limited information to a user that the user must extrapolate on their own, leading to a cognitive burden on visually impaired individuals. With these observations in mind, among others, various aspects of the present disclosure were conceived and developed.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a simplified block diagram showing an assistive feedback device for providing spatial information;

FIG. 2 is a photograph showing a sleeve unit and a control unit of the assistive feedback device of FIG. 1;

FIG. 3 is a photograph showing the assistive feedback device of FIG. 1 positioned along an arm of a user;

FIG. 4 is a photograph showing a sleeve unit of the assistive feedback device of FIG. 1;

FIG. 5 is a photograph showing a control unit of the assistive feedback device of FIG. 1; and

FIG. 6 is an electrical schematic showing the sleeve unit and the control unit of the assistive feedback device of FIG. 1.

Corresponding reference characters indicate corresponding elements among the view of the drawings. The headings used in the figures do not limit the scope of the claims.

### DETAILED DESCRIPTION

Various embodiments of an assistive device for encoding relevant spatial information for blind navigation in a tactile format are disclosed herein. In particular, the assistive device includes an array of vibrotactile actuators and thermal units affixed on a flexible casing that can be worn around the forearm or another part of the body to provide spatial information to a visually impaired person. In some embodiments, the vibrotactile actuators are used for obstacle detection according to a customizable encoding format. Directional cues for navigation can be given using the thermal units according to the customizable encoding format. In some embodiments, the assistive device includes or otherwise communicates with a sensing module for situational awareness.

The perception of tactile information is superior if the actuators are in direct contact with the skin. Designs like vests and haptic belts though effective cannot be easily worn snugly by the user. Having them inside an external layer of clothes may not be comfortable and wearing them externally may lead to poor tactile sensations on skin. On the other hand, simplified ‘vibration notifications’ on a smart-cane might not be able to convey rich information due to a lack of surface area in contact with skin. This may prompt the user to develop a certain grasping procedure for maximal tactile perception. Having tactile feedback in a sleeve form-factor enables close contact with skin, high surface area to enable rich tactile patterns and customizable per the user's needs. From a cognitive standpoint, having a feedback system close to the hand might lead to lower cognitive load on the user in ‘exploring’ their surroundings. In addition, the assistive device uses thermal feedback to enhance the navigational utility of the system e.g., for turn-by-turn navigation.

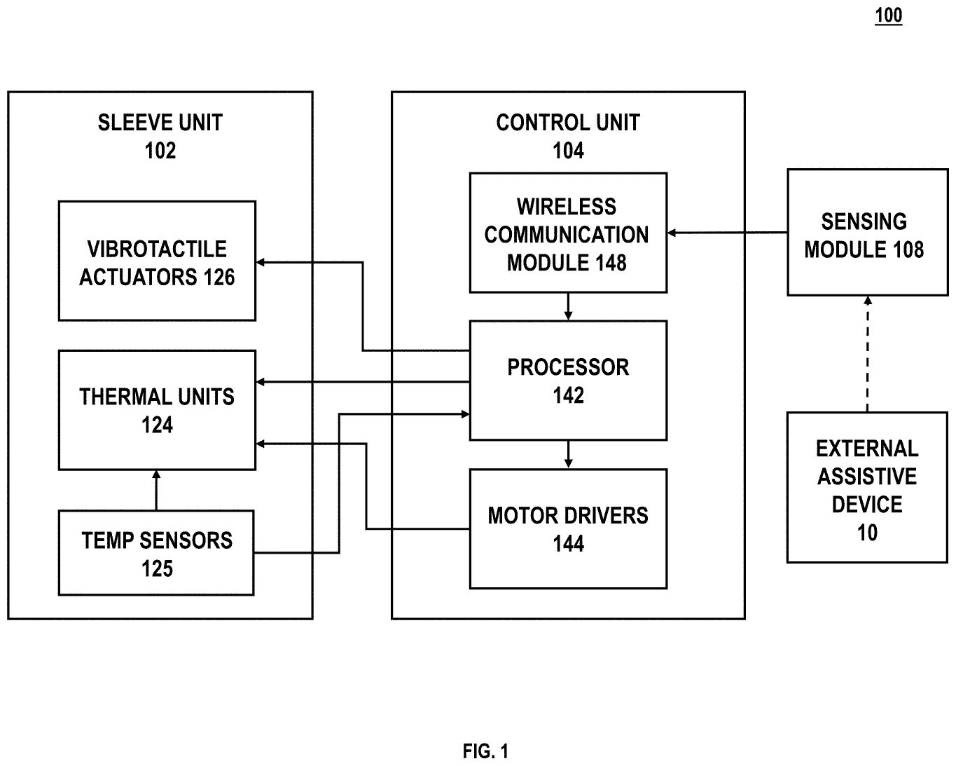

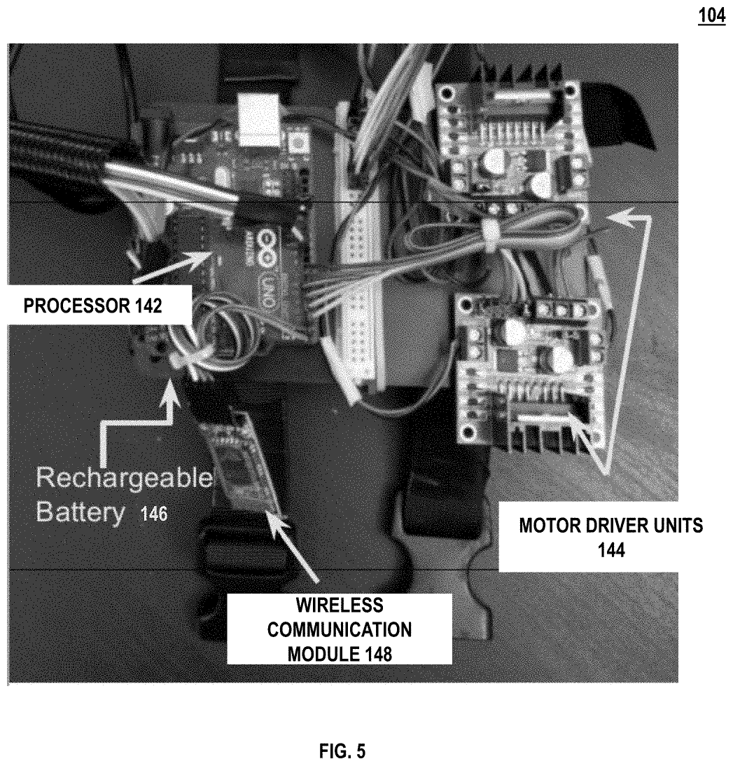

Referring to FIGS. 1-6, an assistive feedback device 100 includes a control unit 104 in communication with a “sleeve unit” 102 that provides vibrothermal feedback to a user. The control unit 104 communicates based on spatial information provided by a sensing module 108 operable for object detection and providing one or more signals to the control unit 104 based on detected obstacles within an area. The control unit 104 is operable to encode the one or more signals from the sensing module 108 into vibrotactile patterns that are applied to the user via components of the sleeve unit 102. In some embodiments, the sensing module 108 can be a component of or otherwise communicate with an external assistive device 10 such as a smartphone or other assistive device. Additionally, the control unit 104 can receive one or more navigation signals from the external assistance device 10. The sleeve unit 102 includes an array of vibrotactile actuators 126 and an array of thermal units 124 positioned along a sleeve 122 that communicate spatial information to a user for obstacle detection and navigation. The larger surface area and direct skin-contact of the sleeve unit 102 serves as one helpful method to convey tactile feedback. The device 100 is wearable and can generate rich stimulation patterns thereby reducing the cognitive load on the user. This device 100 can hence be used with the external existing device 10, including on-hand green or white canes, electronic travel aids (ETAs), multimodal feedback devices (including audio), smartphones and/or AI assistants.

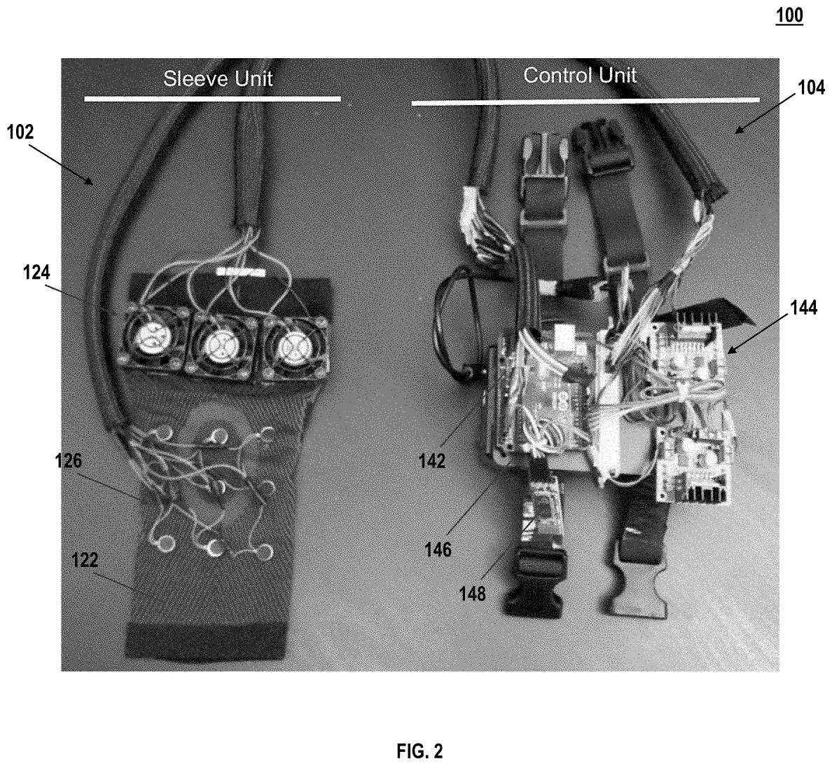

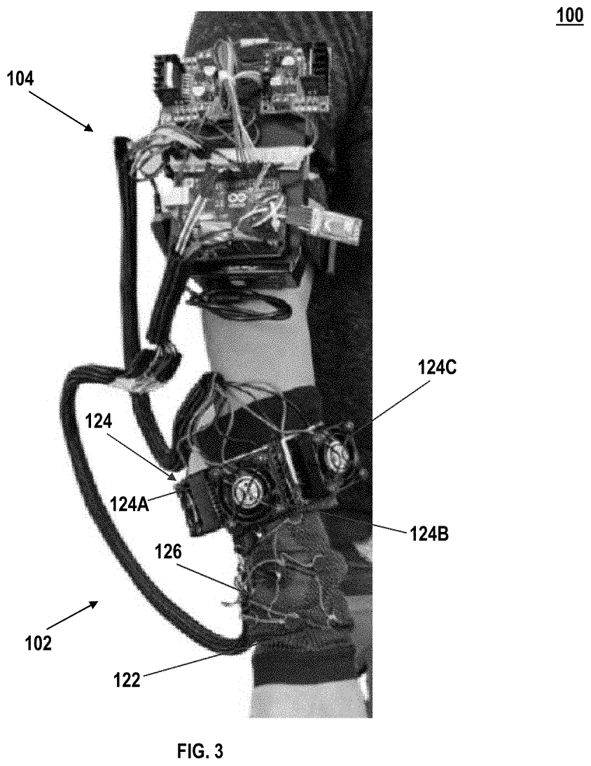

Referring to FIGS. 2 and 3, the assistive feedback device 100 includes two distinct sections that can be worn on the body of the user: the sleeve unit 102 (that houses the components that provide direct tactile feedback) and control unit 104 (that houses the control unit and power supply). In an example embodiment, the control unit 104 is strapped onto the body using buckles or any other appropriate coupling method, and the sleeve 122 of the sleeve unit 102 is made of compressible fabric that clings onto the skin to enhance the tactile sensations from the control unit 104.

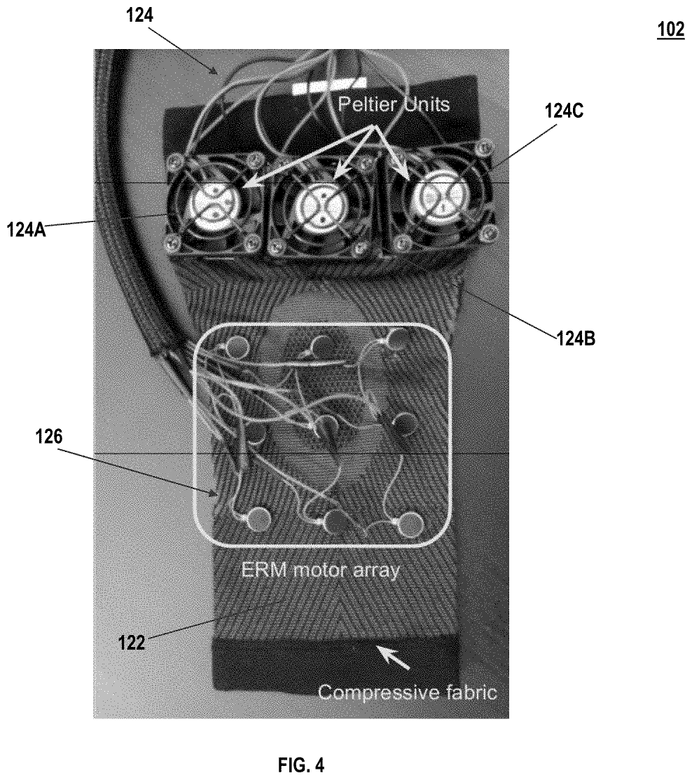

The sleeve unit 102 of the assistive feedback device 100 is shown in FIG. 4 and includes the array of vibrotactile actuators 126 and the array of thermal units 124. The array of vibrotactile actuators 126 are configured to apply a vibrotactile stimulation pattern to a limb of the user to communicate spatial or directional information to the user. The array of thermal units 124 are configured to apply a thermal stimulation pattern to a limb of the user to communicate spatial or directional information to the user. In one embodiment, the array of vibrotactile actuators 126 includes 9 ERM (Eccentric Rotating Mass) motors arranged in a 3×3 matrix, and the array of thermal units 124 includes at least three 20 mm×20 mm Peltier units. The sleeve 122 is configured to expose the thermal units 124 directly to the skin (e.g. can include holes where the thermal units 124 are located or can incorporate the array of thermal units 124 directly into the fabric of the sleeve 122). Each thermal unit 124 can be attached to a heatsink using a thermal pad and uses a fan-based cooling system to generate efficient thermal changes. One example of the fan-based cooling system is illustrated in FIG. 2.

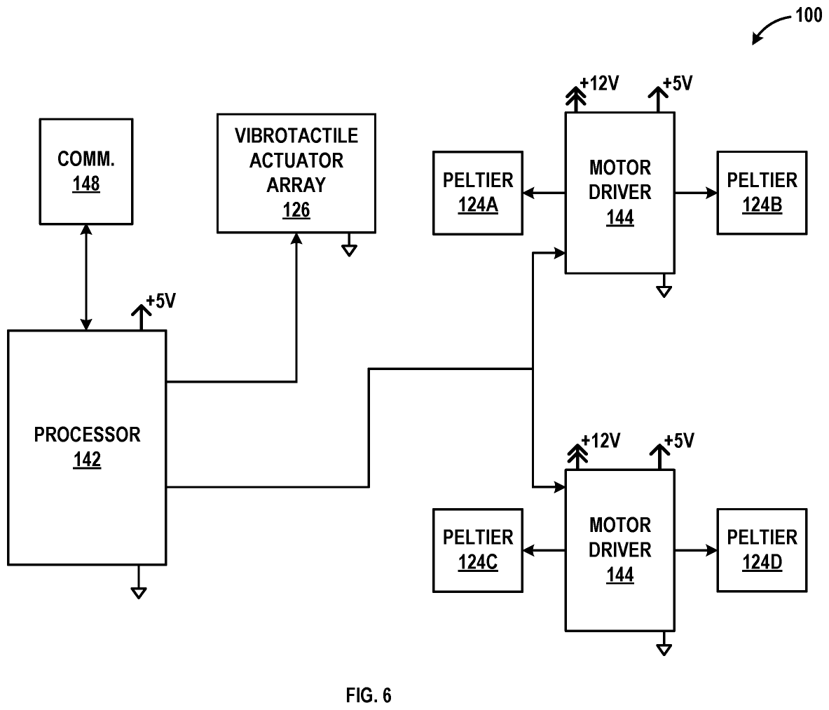

Referring directly to FIGS. 1, 5 and 6, the control unit 104 can include a processor 142 such as a microcontroller for controlling components of the sleeve unit 102. In some embodiments, the processor 142 can receive spatial information from the sensing module 108 directly or through a wireless communication module 148 such as an HC-05 wireless Bluetooth module. The sensing module 108 can include one or more spatial sensors such as ultrasonic or video capture devices. Additionally, the processor 142 can communicate with the external assistive device 10 to receive spatial information or further instructions such as settings related to operation or pattern encoding. The processor 142 encodes spatial information from the sensing module 108 and causes the array of vibrotactile actuators 126 to apply a vibrotactile stimulation pattern to the limb based on the spatial information. Similarly, the processor 142 encodes spatial information from the sensing module 108 and causes the array of thermal units 124 to apply a thermal stimulation pattern to the limb based on the spatial information. In one example stimulation pattern, information about obstacle location (distance, orientation, elevation) is presented to the user through the array of vibrotactile actuators 126 according to the pattern laid out in Table 1; directional information can be provided to the user through the array of thermal units 124 according to Table 1. To switch between warm and cold temperatures on the thermal unit 124, the control unit 104 can include a motor driver 144 (L298D), and the input terminals of the motor driver 144 are controlled through the processor 142 of the control unit 104 to achieve a predetermined temperature stimuli on a particular side of the thermal unit 124. In some embodiments, additional temperature sensors 125 (TMP 36) can be used for temperature feedback from the thermal units 124, to implement a closed-loop system temperature control. As shown, the assistive feedback device 100 can include a portable power supply 146, which supplies the 12V line shown in the electrical schematic of FIG. 6.

The following table describes a sample encoding strategy:

TABLE 1
EXAMPLE ENCODING STRATEGY

| Parameter | Levels | Description |
|---|---|---|
| Distance | 3 | Distance of the object from the user. |
| | | First row (closest to hand): Obstacles within 5 ft. |
| | | Second row: Obstacles 10 ft far. |
| | | Third row: Obstacles 15 ft far. |
| Orienta- | 3 | Right column: Objects located in the right field of |
| tion | | view. |
| | | Center column: Objects located in front of the field |
| | | of view. |
| | | Left column: Objects located in the left field of |
| | | view. |
| | | Here the field of view refers to the direction of |
| | | motion or orientation of the hand on which the |
| | | sleeve is attached. Here the angle of field of view |
| | | is customizable. |
| Elevation | 2 | Short 200 millisecond pulse for ground-level |
| | | objects. |
| | | Short (200 millisecond) pulse followed by a |
| | | longer (300 millisecond) pulse for head-level |
| | | objects. |
| Directions | 3 | Utilizing three Peltiers to give warm/cold feedback |
| | | for left, right or forward directions. |

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. An assistive feedback device comprising:
a sleeve unit configured to contact a limb of a user, the sleeve unit including:
an array of vibrotactile actuators configured to apply a vibrotactile stimulation pattern to the limb of the user; and
an array of thermal units configured to apply a thermal stimulation pattern to the limb of the user; and
a control unit in communication with the sleeve unit, the control unit including:
a processor configured to:
encode spatial information into a vibrothermal stimulation pattern including the vibrotactile stimulation pattern and the thermal stimulation pattern; and
cause the sleeve unit to apply the vibrothermal stimulation pattern to the limb of the user;
wherein the sleeve unit is configured to apply the vibrothermal stimulation pattern to the limb of the user based on spatial information encoded by the control unit.

2. The assistive feedback device of claim 1, wherein the processor is further configured to:
receive the spatial information from a sensing module.

3. The assistive feedback device of claim 1, wherein the sleeve unit covers a limb of a user.

4. The assistive feedback device of claim 1, wherein the spatial information includes directional information.

5. The assistive feedback device of claim 4, wherein the thermal stimulation pattern applied by the array of thermal units provides directional information to the user.

6. The assistive feedback device of claim 1, wherein the spatial information includes obstacle information.

7. The assistive feedback device of claim 4, wherein the vibrothermal stimulation pattern applied by the array of vibrotactile actuators provides obstacle information to the user.

8. An assistive feedback device comprising:
a sleeve unit, including:
one or more vibrotactile actuators that apply a vibrotactile stimulation pattern to a limb of a user; and
a control unit in communication with the sleeve unit that controls the sleeve unit to accommodate obstacle detection, including:
a processor configured to:
encode spatial information for blind navigation in a tactile format such that the processor causes the sleeve unit to apply a vibrotactile stimulation pattern to the limb of the user.

9. The assistive feedback device of claim 8, wherein the sleeve unit further includes:
one or more thermal units configured to apply a thermal stimulation pattern to the limb of the user.

10. The assistive feedback device of claim 9, wherein the one or more thermal units includes Peltier devices that transfer heat from one side of the one or more thermal units to another to applying cooling and/or heating feedback.

11. The assistive feedback device of claim 8, wherein the control unit is configured to engage a body of the user along a first section, and the sleeve unit is configured to engage the body of the user along a second section separate from the first section.

12. The assistive feedback device of claim 8, wherein the sleeve unit is configured for direct skin contact with the user.

13. The assistive feedback device of claim 8, wherein the vibrotactile stimulation pattern is customizable for a predetermined need of the user.

14. The assistive feedback device of claim 8, wherein the sleeve unit includes a flexible casing such that the sleeve unit is wearable along a forearm of the user proximate to a hand of the user.

15. The assistive feedback device of claim 8, wherein the sleeve unit includes a sleeve comprising compressible fabric that clings onto skin to enhance tactile sensations from the control unit.

16. The assistive feedback device of claim 8, wherein the one or more vibrotactile actuators includes one or more eccentric rotating mass (ERM) motors.

17. The assistive feedback device of claim 8, further comprising:
a sensing module including one or more spatial sensors that provides spatial information including detected obstacles within an area around the user, wherein the control unit encodes the spatial information to produce vibrotactile patterns applied by the sleeve unit.

18. A device for assistive feedback comprising one or more vibrotactile actuators arranged along a sleeve unit that provide tactile feedback to a user, the one or more vibrotactile actuators controlled by a control unit to accommodate obstacle detection.

19. The device of claim 18, further comprising one or more thermal units in operative communication with the control unit that enhance navigational utility.

20. The device of claim 18, wherein the sleeve unit is configured for at least close contact with skin of the user proximate to a hand of the user, and accommodates greater surface area to enable rich tactile patterns for the user.
